(19) United States
(12) Patent Application Publication
(10) Pub. No.: US 2017/0003132 A1
(43) Pub. Date: Jan. 5, 2017

(54) METHOD OF CONSTRUCTING STREET GUIDANCE INFORMATION DATABASE, AND STREET GUIDANCE APPARATUS AND METHOD USING STREET GUIDANCE INFORMATION DATABASE

(71) Applicant: ELECTRONICS AND TELECOMMUNICATIONS RESEARCH INSTITUTE, Daejeon (KR)

(72) Inventors: Ju Wan KIM, Daejeon (KR); Jung Sook KIM, Daejeon (KR); Jeong Dan CHOI, Daejeon (KR)

(21) Appl. No.: 15/135,940

(22) Filed: Apr. 22, 2016

(30) Foreign Application Priority Data
Feb. 23, 2015 (KR) 10-2015-0025074
May 27, 2015 (KR) 10-2015-0073699

(51) Int. Cl. G01C 21/20; G06F 17/30; G06T 7/00; G06F 3/16; H04N 7/18; G06K 9/46

(52) U.S. Cl. CPC G01C 21/20; H04N 7/183; G06K 9/4604; G06T 7/0042; G06F 3/16; G06F 17/30477; G06T 2207/30244; G06T 2207/30196; G06T 2207/30241

(57) ABSTRACT

A walking guidance apparatus using a walking guidance information database includes a feature point extracting unit configured to extract a feature point from an acquired image, a corresponding point search unit configured to search for a corresponding point based on a correspondence relationship between feature points extracted from consecutive images, a current position and walking direction calculation unit configured to calculate a current position and a walking direction of a pedestrian by calculating a 3D position and pose of a camera between the images by using camera internal parameters and a relationship between corresponding points, a guidance information generating unit configured to generate guidance information according to the current position and the walking direction of the pedestrian, and a guidance sound source reproducing unit configured to reproduce a guidance sound source corresponding to the guidance information in 3D based on the current position and the walking direction of the pedestrian.

### CROSS-REFERENCE TO RELATED APPLICATION

This application claims priority to and the benefit of Korean Patent Application No. 10-2015-0025074, filed Feb. 23, 2015, and Korean Patent Application No. 10-2015-0073699, filed May 27, 2015, the disclosure of which is incorporated herein by reference in its entirety.

### BACKGROUND

1. Field of the Disclosure

The present invention relates to a method of constructing a walking guidance information database, a walking guidance apparatus and a method using the walking guidance information database, and more particularly, a walking guidance apparatus and a method for assisting walking of a visually impaired person who independently walks by constructing a walking guidance information database in a walking training stage, comparing a walking condition in the walking training stage with a current walking condition, notifying a result of the comparison, and notifying information about a landmark to be referred to when confirming a location during walking as a three-dimensional sound.

2. Discussion of Related Art

In general, visually impaired people have difficulty obtaining information about outside environments, so their walking is significantly limited, and they also have difficulty properly coping with danger, such as an obstacle.

Currently, domestically and internationally, research is being actively conducted on assistance devices and systems for safe walking of visually impaired people.

According to a conventional walking guidance system for a visually impaired person, guidance information for assisting the visually impaired person with walking is provided using ultrasonic waves, a tactile sensation, a laser, a global positioning system (GPS), a camera, and so on.

A visually impaired person walking guidance system using ultrasonic waves involves putting on a set of ultrasonic sensors provided in the form of a belt, analyzing information about each direction using a computer that is put on in the form of a bag, and notifying a visually impaired person of a result of the analysis. The visually impaired person walking guidance system using ultrasonic waves offers relatively easy implementation and less computation, but it can only determine the existence of a surrounding obstacle, and it cannot obtain information about a texture and a color of an object, and it has a large number of limitations in obtaining movement information of the object.

Another example of a visually impaired person walking guidance system using ultrasonic waves is a road guidance system provided in the form of a stick. The road guidance system is provided to detect an obstacle by mounting an ultrasonic sensor on a guidance stick for a visually impaired person and guides a route in a direction that is not dangerous. The road guidance system has a simple structure and offers easy applicability, but because it can only detect a nearby small obstacle positioned in front of the system, there is a limitation in detection distance.

A visually impaired person walking guidance system using a laser has a benefit that a user can obtain local information about a surrounding area of the system by holding and shaking a laser sensor tool from side to side, and the user can obtain depth information that has a bend or is not easily identified using a single camera by analyzing hazards for movement, such as a step and a cliff, in terms of sight. However, the visually impaired person walking guidance system using a laser is only applied to an adjacent region and cannot identify features of a color or a texture of a detected object.

A visually impaired person walking guidance system using GPS is a system which guides a route for a pedestrian using local map information that is empirically obtained and stored in advance, in which a sequential route to a destination is provided. The visually impaired person walking guidance system using the GPS has a database containing local information, enables communication between a computer and a human through a voice conversion technology and a voice recognition technology, and provides a route to a destination in a certain area, thereby ensuring a convenience of use. However, the visually impaired person walking guidance system using the GPS has difficulty analyzing the danger of elements that are adjacent to a walker.

### SUMMARY OF THE DISCLOSURE

The present invention is directed to a method of constructing a walking guidance information database capable of being used without an additional equipment investment for infrastructure and which may be used in a propagation shadow area, such as underground or indoors, and an area having no map for position mapping, a walking guidance apparatus using the walking guidance information database, and a walking guidance method using the walking guidance information database.

The technical objectives of the inventive concept are not limited to the above disclosure; other objectives may become apparent to those of ordinary skill in the art based on the following descriptions.

In accordance with one aspect of the present invention, there is provided a walking guidance apparatus using a walking guidance information database, the walking guidance apparatus including a feature point extracting unit, a corresponding point search unit, a current position and walking direction calculation unit, a guidance information generating unit and a guidance sound source reproducing unit. The feature point extracting unit may be configured to extract a feature point from an acquired image. The corresponding point search unit is configured to search for a corresponding point based on a correspondence relationship between feature points extracted from consecutive images. The current position and walking direction calculation unit is configured to calculate a current position and a walking direction of a pedestrian by calculating a three-dimensional (3D) position and pose of a camera between the images using camera internal parameters and a relationship between corresponding points. The guidance information generating unit is configured to generate guidance information according to the current position and the walking direction of the pedestrian by referring to the walking guidance information database. The guidance sound source reproducing unit is configured to reproduce a guidance sound source corresponding to the guidance information in three dimensions based on the current position and the walking direction of the pedestrian.

When a relationship between each corresponding point found in an adjacent image and the camera does not correspond to a relationship between images defined by epipolar geometry, the corresponding point search unit may remove the corresponding point.

The current position and walking direction calculation unit may calculate the 3D position and pose of the camera between the images by using the camera internal parameters and the relationship between corresponding points, and compensate for scales of the 3D position and pose of the camera by using an actual size of an object included in the acquired image.

The current position and walking direction calculation unit may calculate the current position and walking direction of the pedestrian by accumulating variations between a 3D position and pose of the camera calculated in an image captured at an initial position and a 3D position and pose of the camera calculated in an image captured after capturing the image at the initial position.

The guidance information generating unit may generate the guidance information including route deviation information and walking speed comparison information by comparing route trajectory information for a walking zone, a walking speed in the walking zone, and a time duration in the walking zone that are stored in the walking guidance information database with the current position and walking direction of the pedestrian.

The guidance information generating unit may search for a landmark within a walking guidance range that is preset based on the current position of the pedestrian from the walking guidance information database, and calculates a relative distance and a direction of a found landmark based on the current position and walking direction of the pedestrian.

The guidance sound source reproducing unit may adjust a reproduction position and a reproduction direction of a guidance sound source corresponding to the guidance information based on the relative distance and the direction of the landmark.

In accordance with another aspect of the present invention, there is provided a walking guidance method using a walking guidance information database, the walking guidance method including: extracting a feature point from an acquired image; searching for a corresponding point based on a correspondence relationship between feature points extracted from consecutive images; calculating a current position and a walking direction of a pedestrian by calculating a 3D position and pose of a camera between the images using camera internal parameters and a relationship between corresponding points; generating guidance information according to the current position and the walking direction of the pedestrian by referring to the walking guidance information database; and reproducing a guidance sound source corresponding to the guidance information in three dimensions based on the current position and the walking direction of the pedestrian.

The searching for a corresponding point may include removing the corresponding point when a relationship between each corresponding point found in an adjacent image and the camera does not correspond to a relationship between images defined by epipolar geometry.

The calculating of the current position and the walking direction of the pedestrian may include calculating the 3D position and pose of the camera between the images using the camera internal parameters and the relationship between corresponding points, and compensating for scales of the 3D position and pose of the camera using an actual size of an object included in the acquired image.

The calculating of the current position and walking direction of the pedestrian may include calculating the current position and walking direction of the pedestrian by accumulating variations between a 3D position and pose of the camera calculated in an image captured at an initial position and a 3D position and pose of the camera calculated in an image captured after capturing the image at the initial position.

The generating of the guidance information may include generating the guidance information including route deviation information and walking speed comparison information by comparing route trajectory information for a walking zone, a walking speed in the walking zone, and a time duration in the walking zone that are stored in the walking guidance information database with the current position and walking direction of the pedestrian.

The generating of the guidance information may include: searching for a landmark within a walking guidance range that is preset based on the current position of the pedestrian from the walking guidance information database; and calculating a relative distance and a direction of a found landmark based on the current position and walking direction of the pedestrian.

The reproducing of the guidance sound source may include adjusting a reproduction position and a reproduction direction of a guidance sound source corresponding to the guidance information based on the relative distance and the direction of the landmark.

In accordance with one aspect of the present invention, there is provided a method of constructing a walking guidance information database, the method including: constructing pedestrian route data including information about positions and postures of a pedestrian which moved by accumulating variations between a 3D position and pose of a camera calculated in an image captured at an initial position and a 3D position and pose of the camera calculated in an image captured after capturing the image at the initial position; and constructing landmark data including a position of a landmark set by a user based on the initial position, guidance information for the landmark, and a walking guidance range.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an example illustrating an environment of a walking guidance apparatus using a walking guidance information database according to an embodiment of the present invention;

FIG. 2 is a flowchart illustrating a method of constructing the walking guidance information database according to the embodiment of the present invention;

FIG. 3 is a flowchart for describing a process of calculating three-dimensional (3D) coordinates of position and pose values of a camera and corresponding points in the embodiment of the present invention;

FIG. 4 is an example illustrating a relationship between a camera and corresponding points in the embodiment of the present invention;

FIG. 5 is a block diagram illustrating a walking guidance apparatus using the walking guidance information database according to the embodiment of the present invention;

FIG. 6 is an example illustrating a process of calculating the position and direction of a landmark located in a sightline direction of a pedestrian in the embodiment of the present invention; and

FIG. 7 is a flowchart illustrating a walking guidance method using the walking guidance information database according to the embodiment of the present invention.

### DETAILED DESCRIPTION OF EXEMPLARY EMBODIMENTS

The above objects and advantages, and a scheme for the advantages of the present invention should become readily apparent by reference to the following detailed description when considered in conjunction with the accompanying drawings. However, the scope of the present invention is not limited to such embodiments and the present invention may be realized in various forms. The embodiments to be described below are merely exemplary embodiments provided to fully disclose the present invention and assist those skilled in the art to completely understand the present invention, and the present invention is defined only by the scope of the appended claims. The specification drafted as such is not limited to the detailed terms suggested in the specification. The terminology used herein is for the purpose of describing particular embodiments only and is not intended to be limiting to the disclosure. As used herein, the singular forms “a”, “an” and “the” are intended to include the plural forms as well, unless the context clearly indicates otherwise. It should be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In assigning reference numerals to elements, the same reference numerals are used to designate the same elements throughout the drawings, and in describing the present invention, detailed descriptions that are well-known but are likely to obscure the subject matter of the present invention will be omitted in order to avoid redundancy.

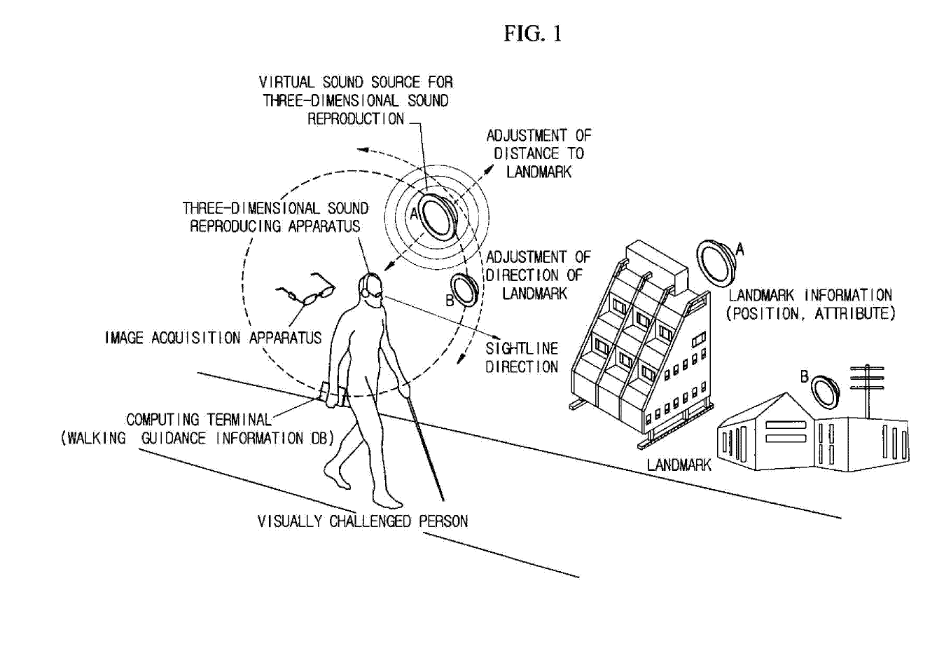

FIG. 1 is an example illustrating an environment of a walking guidance apparatus using a walking guidance information database according to an embodiment of the present invention.

Referring to FIG. 1, a walking guidance apparatus using a walking guidance information database according to an embodiment of the present invention includes an image acquisition apparatus which acquires image information about a surrounding environment, a three-dimensional (3D) sound reproducing apparatus, and a computing terminal.

The image acquisition apparatus may be a wearable device which acquires image information about a surrounding environment in a state of being worn on a pedestrian, and may include two or more cameras so that an image having a wide angle of view is acquired or stereo images are acquired, but the present invention is not limited thereto.

The walking guidance apparatus may include GPS or IMU(Inertial Measurement Unit) to acquire auxiliary information.

The image acquired by the image acquisition apparatus is transmitted to the computing terminal, and the computing terminal generates route information by processing the acquired image to calculate a position and a pose of the pedestrian.

The computing terminal is provided with a pre-constructed walking guidance information database, and the computing terminal generates guidance information for the pedestrian by comparing walking guidance information stored in the walking guidance information database with current route information of the pedestrian that is acquired through the image processing.

The walking guidance information database is pre-constructed with respect to a certain walking route in a walking training stage, and the walking guidance information database includes image-based pedestrian route data and user-setting based landmark data. The pedestrian route data includes camera calibration information, an input image sequence, a feature point, a corresponding point, camera position and pose information, and a time stamp, which are used for a walking guidance apparatus, which will be described below, to calculate route trajectory information for a certain walking zone, a walking speed in the walking zone, and a time duration in each walking zone. The landmark data is set by a user as a point (for example, a certain building) which is considered in need of a landmark guidance to confirm a walking position in the walking training stage, and includes the position of the point (a landmark), guidance information, and a walking guidance range, which are used for the walking guidance apparatus, which will be described below, to provide guidance information about the landmark in the form of a sound or acoustic data when a pedestrian approaches the walking guidance range with respect to the position of the landmark.

The guidance information transmitted to the pedestrian is generated by referring to a walking guidance information database pre-constructed in the walking training stage. That is, a walking guidance information database for a certain route is pre-constructed, and when a pedestrian moves along the same route, the pedestrian is periodically provided with the current walking condition by comparing the movement with a walking condition of a past walking training stage. The guidance information transmitted to the pedestrian may include information related to a walking speed, such as ‘similar’, ‘slower’, and ‘faster’ compared to the past, information related to the degree of route deviation compared to a past trajectory, and primary walking guidance information for the next pedestrian route (for example, rotation information, landmark information, and so on).

The 3D sound reproducing apparatus transmits information about a landmark that exists within the walking guidance range based on the current position and the current walking direction (or the sightline direction) of the pedestrian in a 3D manner. For example, as illustrated in FIG. 1, when it is assumed that a landmark A and a landmark B exist in the walking guidance range on a pedestrian route, the walking guidance apparatus, which will be described below, calculates a relative distance and a direction of each of the landmark A and the landmark B based on the current position and the current walking direction of a pedestrian. Then, the walking guidance apparatus adjusts the position in which a virtual sound source corresponding to guidance information is reproduced, a direction in which the virtual sound source is reproduced, and a volume at which the virtual sound source is reproduced according to the calculated relative distance and direction.

Because the landmark A is located at a position relatively nearer to the pedestrian than the landmark B, guidance information for the landmark A is reproduced at a volume higher than a volume corresponding to guidance information for the landmark B, and when the landmark A and the landmark B are located in different directions, the position and direction in which the guidance information corresponding to the landmark A is reproduced and the position and direction in which the guidance information corresponding to the landmark B is reproduced may be adjusted to be different from each other, so that the pedestrian recognizes information about a surrounding environment in a 3D manner.

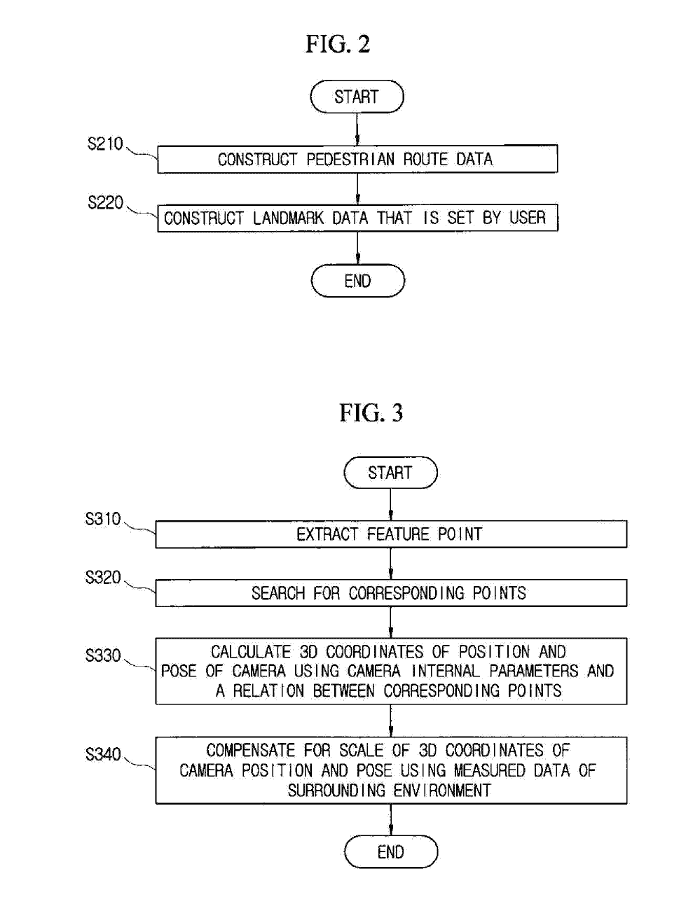

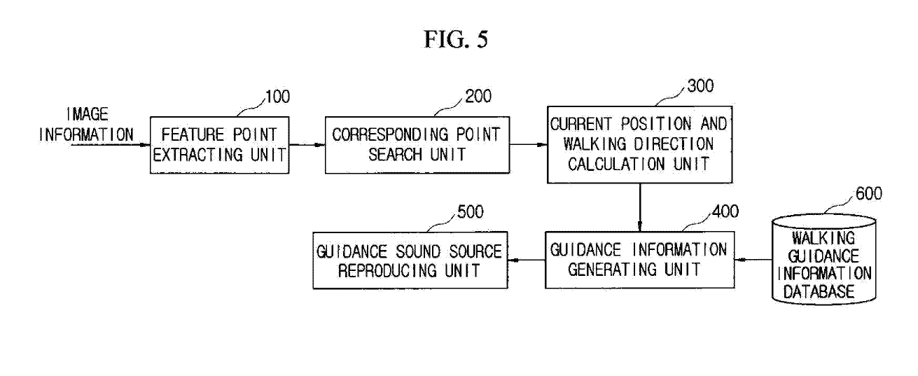

Hereinafter, a method of constructing a walking guidance information database, a walking guidance apparatus using the walking guidance information database and a walking guidance method using the walking guidance information database will be described with reference to FIGS. 2 to 7. First, a method of constructing a walking guidance information database according to an embodiment of the present invention will be described with reference to FIGS. 2 to 4, and then the walking guidance apparatus using the walking guidance information database and the walking guidance method using the walking guidance information database will be described with reference to FIGS. 5 to 7.

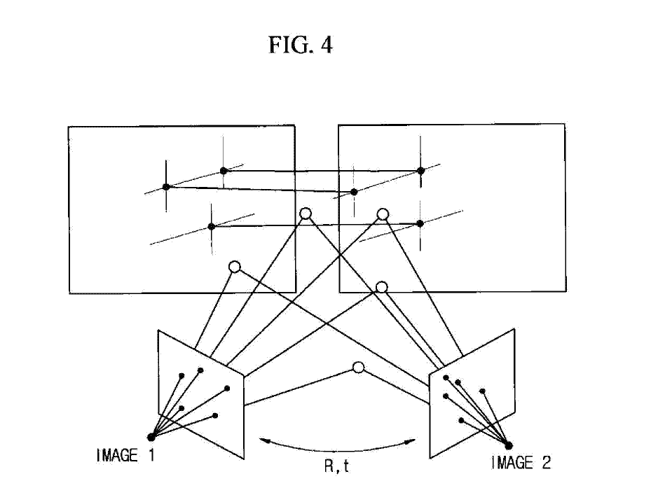

FIG. 2 is a flowchart illustrating a method of constructing the walking guidance information database according to the embodiment of the present invention, FIG. 3 is a flowchart for describing a process of calculating 3D coordinates of position and pose values of a camera and corresponding points in the embodiment of the present invention, and FIG. 4 is an example illustrating a relationship between a camera and corresponding points in the embodiment of the present invention.

Referring to FIG. 2, a walking guidance apparatus constructs pedestrian route data including moving position and pose information of a pedestrian by accumulating variations between a 3D position and pose of a camera calculated in an image captured at an initial position and a 3D position and pose of the camera calculated in an image captured after capturing the image at the initial position (S210).

It is assumed that the camera used to acquire an image during a walking of a visually impaired person has internal parameters already known through a calibration process.

The pedestrian route data includes camera calibration information, an input image sequence, a feature point, a corresponding point, camera position and pose information, and a time stamp, and in this case, an image processing based technology is used.

Referring to FIG. 3, the walking guidance apparatus extracts feature points from images acquired by the camera (S310) and searches for corresponding points with respect to the extracted feature points in another image adjacent to the image (S320). In this case, a technique, such as a random sample consensus (RANSAC) technique, is used to remove corresponding points whose relation with the camera does not match epipolar geometry. Epipolar geometry represents a theory in which, when two cameras acquire image information about the same point in a 3D space, two vectors respectively formed by the position of each of the cameras and an image point looking at the same point need to lie on a common plane.

As shown in FIG. 4, the walking guidance apparatus calculates information about a 3D position and pose of the camera between adjacent images by performing an optimization process having the position and pose of the cameras as variables by using camera internal parameters and a relation between corresponding points (S330).

The optimization process may be performed using a method such as a sparse bundle adjustment, etc., and the sparse bundle adjustment may represent a process of finding optimum coordinate value for camera position and pose values of the camera and a corresponding point so that an error generated when position coordinates of the corresponding point are reprojected onto an image is minimized.

A scale value of the 3D position coordinates obtained as above is not known, and the walking guidance apparatus compensates for the scale of 3D position coordinate values by actually measuring or estimating the length of a curb, the length of a column and the size of a certain object around a walking environment to determine scale information (S340).

Accordingly, the walking guidance apparatus may calculate the moving position and pose information (direction information) of the pedestrian by accumulating variations between a 3D position and pose of the camera calculated in an image captured at an initial position and a 3D position and pose of the camera calculated in an image captured after capturing the image at the initial position.

Then, the walking guidance apparatus constructs landmark data including the position of a landmark set by a user, guidance information, and a walking guidance range based on the initial position (S220).

In a walking training stage, the walking guidance apparatus generates landmark data including the position of a landmark and guidance information at a point which is considered in need of landmark guidance to support a walking position confirmation, and stores the generated landmark data in the walking guidance information database.

In order to set a landmark desired by a pedestrian, the position of the landmark needs to be calculated. In this case, a process of selecting a landmark from two or more images is necessary. In addition, a 3D coordinate value for coordinates may be calculated through a perspective projection formula by using an image point, camera calibration information, and the camera position and pose information as inputs, and landmark data, including a proximity range value for providing a pedestrian with guidance information and guidance information to be actually provided is stored in the walking guidance information database.

The landmark data stores a position value for a landmark with respect to the initial position, guidance information and a guidance service range value, and when a pedestrian approaches within a predetermined range with respect to the position of the landmark, the guidance information for the landmark is provided in the form of a voice, a sound, or the like that is easily perceived by the pedestrian.

FIG. 5 is a block diagram illustrating a walking guidance apparatus using the walking guidance information database according to the embodiment of the present invention.

Referring to FIG. 5, a walking guidance apparatus using the walking guidance information database according to the embodiment of the present invention includes a feature point extracting unit 100, a corresponding point search unit 200, a current position and walking direction calculation unit 300, a guidance information generating unit 400, a guidance sound source reproducing unit 500, and a walking guidance information database 600.

The feature point extracting unit 100 extracts a feature point from each image sequence acquired by a camera.

For example, the feature point extracting unit 100 may extract a feature point that may serve as a feature of an image using pixels corresponding to a global area or a certain local area in input image information. In this case, the feature point represents a corner and a blob. The feature point is composed of a vector, but is assigned a unique scale and a unique direction. The feature point is composed relative to the scale and the direction, so is robust even when scale or a rotation is changed.

Typical examples of a feature extraction algorithm include scale invariant feature transform (SIFT), speeded up robust feature (SURF), and features from accelerated segment test (FAST).

The corresponding point search unit 200 tracks a feature point extracted from a previous image frame and searches for a corresponding point based on a correspondence relationship between the tracked feature point and a feature point extracted from the current image frame. In this case, a technique, such as a RANSAC technique, may be used to remove corresponding points whose relation with the camera does not match epipolar geometry. Epipolar geometry represents a theory in which, when two cameras acquire image information about the same point in a 3D space, two vectors respectively formed by the position of each of the cameras and an image point looking at the same point need to lie on a common plane.

The current position and walking direction calculation unit 300 calculates a current position and a current walking direction of a pedestrian by calculating a 3D position and pose of the camera between the images by using camera internal parameters and a relationship between corresponding points.

The current position and walking direction calculation unit 300 calculates the current position and the current walking direction of the pedestrian by accumulating variations between a 3D position and pose of the camera calculated in an image captured at an initial position and a 3D position and pose of the camera calculated from an image captured after capturing the image at the initial position.

That is, the current position and walking direction calculation unit 300 calculates information about a 3D position and pose of the camera between adjacent images by performing an optimization process having the position and pose of the camera as variables by using camera internal parameters and a relation between corresponding points. The optimization process may be performed by using the sparse bundle adjustment, and the sparse bundle adjustment may represent a process of finding an optimum coordinate value for camera position and pose values and a corresponding point such that an error generated when position coordinates of the corresponding point are reprojected onto an image is minimized.

In this case, the current position and walking direction calculation unit 300 calculates a 3D position and pose of the camera between images by using the internal parameters of the camera and the relationship between corresponding points, and compensates for scales of the 3D position and pose of the camera using an actual size of a certain object included in the acquired image.

The guidance information generating unit 400 generates guidance information according to the current position and the walking direction of the pedestrian by referring to the walking guidance information database 600.

For example, the guidance information generating unit 400 generates guidance information including route deviation information and walking speed comparison information by comparing route trajectory information for a walking zone, a walking speed in the walking zone, and a time duration in the walking zone that are stored in the walking guidance information database 600 with the current position and walking direction of the pedestrian. The guidance information transmitted to the pedestrian is generated by referring to the walking guidance information database 600 that is pre-constructed in a walking training stage. That is, the walking guidance information database 600 for a certain route is pre-constructed, and when a pedestrian moves along the same route, the pedestrian is periodically notified of the current walking condition by comparing the movement with a walking condition in a past walking training stage. The guidance information transmitted to the pedestrian may include information related to a walking speed, such as ‘similar’, ‘slower’, and ‘faster’ compared to the past, information related to the degree of route deviation compared to a past trajectory, and primary walking guidance information for the next pedestrian route (for example, rotation information, landmark information, and so on).

In addition, the guidance information generating unit 400 searches for a landmark existing within the walking guidance range that is preset based on the current position of the pedestrian in the walking guidance information database 600, and calculates a relative distance and a direction of a found landmark based on the current position and walking direction of the pedestrian.

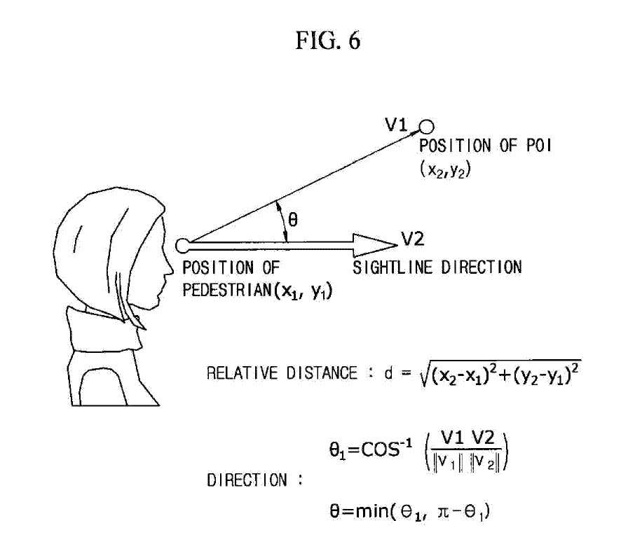

FIG. 6 is an example illustrating a process of calculating the position and direction of a landmark located in a sightline direction of a pedestrian in the embodiment of the present invention. Referring to FIG. 6, when the current position of a pedestrian has coordinates x1 and y1 and the position of a landmark has coordinates x2 and y2, a relative distance of the landmark from the current position of the pedestrian with respect to the walking direction (or the sightline direction) of the pedestrian is calculated as Equation 1 below, and the direction of the landmark is calculated as Equation 2 below.

$$\begin{matrix}Relative distance ( d ) = \sqrt{{( x 2 - x 1 )}^{2} + {( y 2 - y 1 )}^{2}} & [ Equation 1 ] \\ Direction ( ⊖ ) = min \{ {θ}_{1} , Π - {θ}_{1} \} , {θ}_{1} = {cos}^{- 1} ( \frac{v 1 v 2}{\vert v 1 \vert \vert v 2 \vert} ) & [ Equation 2 ]\end{matrix}$$

Here, v1 represents a position vector of a walking direction, and v2 represents a position vector of a landmark.

The guidance sound source reproducing unit 500 transmits information about a landmark that exists in the walking guidance range with respect to the current position and the walking direction (or the sightline direction) of the pedestrian to the pedestrian in a 3D manner.

For example, the guidance sound source reproducing unit 500 adjusts a reproduction position, a reproduction direction and a volume of a guidance sound source corresponding to the guidance information based on the relative distance and the direction of the landmark so that the guidance information is transmitted to the pedestrian in a 3D manner. The sound reproduced from the guidance sound source may include “this is an entrance of XX building”, “this is a men's rest room”, “a crosswalk is on the 00 side”, and the sound may be variously set to assist the pedestrian at the current walking position and condition. In addition, in order for the pedestrian to recognize information about the landmark through the guidance sound source in a 3D manner, the direction and the volume of the sound corresponding to the guidance sound source reproduced from the guidance sound source reproducing unit 500 may be adjusted according to the relative distance and the direction of the landmark. That is, the sound may be emitted from a direction in which the landmark is located with respect to the walking direction of the pedestrian, and the volume of the sound may vary in proportion to the distance to the landmark.

Hereinafter, a method of detecting an obstacle using a difference image according to the embodiment of the present invention will be described. In the following description, details of operations identical to those of the walking guidance apparatus using the walking guidance information database according to the embodiment of the present invention described with reference to FIGS. 5 and 6 will be omitted.

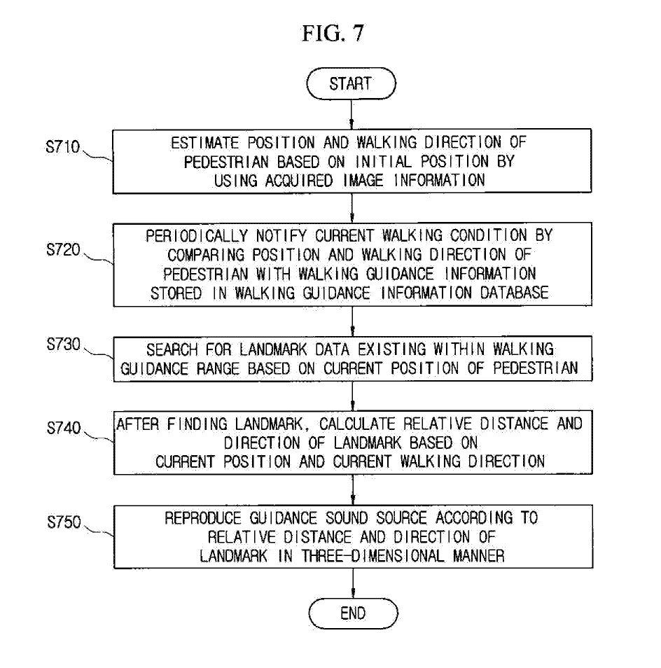

FIG. 7 is a flowchart illustrating a walking guidance method using the walking guidance information database according to the embodiment of the present invention.

Referring to FIGS. 5 to 7, the walking guidance apparatus estimates a position and a walking direction of a pedestrian based on an initial position by using acquired image information (S710)

The walking guidance apparatus extracts feature points from images acquired by a camera, and searches for corresponding points with respect to the extracted feature points in another image adjacent to the image. In this case, a technique, such as a RANSAC technique, may be used to remove corresponding points whose relation with the camera does not meet epipolar geometry. Epipolar geometry represents a theory in which, when two cameras acquire image information about the same point in a 3D space, two vectors respectively formed by the position of each of the cameras and an image point looking at the same point need to lie on a common plane.

The walking guidance apparatus calculates information about a 3D position and pose of the camera between adjacent images by performing an optimization process having the position and pose of the cameras as variables by using camera internal parameters and a relation between corresponding points as shown in FIG. 4.

Then, the walking guidance apparatus periodically notifies the current walking condition by comparing the position and the walking direction of the pedestrian with the walking guidance information stored in the walking guidance information database (S720).

The guidance information periodically transmitted to the pedestrian is generated by referring to the walking guidance information database that is pre-constructed in a walking training stage. That is, because the walking guidance information database with respect to a certain route is pre-constructed, when a pedestrian moves along the same route, the pedestrian is periodically notified of the current walking condition by comparing the movement with a walking condition in a past walking training stage. The guidance information transmitted to the pedestrian may include information related to a walking speed, such as ‘similar’, ‘slower’, and ‘faster’ compared to the past, information related to the degree of route deviation compared to a past trajectory, and primary walking guidance information for the next pedestrian route.

Then, the walking guidance apparatus searches for a landmark existing within a walking guidance range based on the current position of the pedestrian (S730).

In the walking training stage, the walking guidance apparatus generates landmark data including a position and guidance information at a position which is considered in need of a landmark guidance to support a walk position confirmation, and stores the generated landmark data in the walking guidance information database. When a pedestrian approaches within a predetermined range with respect to the position of a landmark, the walking guidance apparatus searches for landmark and guidance information for the landmark in the walking guidance information database.

Then, the walking guidance apparatus, after having found the landmark, calculates a relative distance and a direction of the landmark based on the current position and the current walking direction (S740).

Then, the walking guidance apparatus reproduces a guidance sound source corresponding to the guidance information according to the relative distance and the direction of the landmark in a 3D manner (S750).

For example, the walking guidance apparatus may transmit the guidance information to the pedestrian in a 3D manner by adjusting a reproduction position, a reproduction direction and a volume of the guidance sound source corresponding to the guidance information based on the relative distance and the direction of the landmark.

According to the embodiment of the present invention, because the walking guidance is performed using a walking guidance information database constructed in a walking training stage, walking guidance information can be provided that is more accurate and appropriate to the pedestrian.

In addition, the embodiment of the present invention has an advantage in that it does not generate a positioning shadow area when using a positioning method, such as a GPS, and it can be used without detailed map information.

In addition, the present invention can identify the position and the direction of a landmark using a personalized 3D sound. Conventional technologies, such as a voice guidance device and a sound signal device, causes difficulty in recognizing a precise distance and direction with respect to a sound source due to ambient noise. However, in a personalized 3D sound guidance apparatus, which provides information by placing a sound source in a virtual space based on the position of an individual, the distance and direction with respect to a point of interest (POI) can easily be recognized. The personalized 3D sound guidance apparatus can prevent any sound from being heard by other people except for the individual thereby reducing a complaint raised with regard to noise occurring when sound guidance is provided to other people.

Although the present invention has been described above, it should be understood that there is no intent to limit the present invention to the particular forms disclosed, but on the contrary, the disclosure is to cover all modifications, equivalents, and alternatives falling within the spirit and scope of the disclosure. Therefore, the exemplary embodiments disclosed in the present invention and the accompanying drawings are not intended to limit but illustrate the technical spirit of the present invention, and the scope of the present invention is not limited by the exemplary embodiments and the accompanying drawings. A protective scope of the present invention should be construed on the basis of the accompanying claims and all of the technical ideas included within the scope equivalent to the claims should be construed as belonging thereto.

What is claimed is:

1. A walking guidance apparatus using a walking guidance information database, the walking guidance apparatus comprising:
a feature point extracting unit configured to extract a feature point from an acquired image;
a corresponding point search unit configured to search for a corresponding point based on a correspondence relationship between feature points extracted from consecutive images;
a current position and walking direction calculation unit configured to calculate a current position and a walking direction of a pedestrian by calculating a three-dimensional (3D) position and pose of a camera between the images by using camera internal parameters and a relationship between corresponding points;
a guidance information generating unit configured to generate guidance information according to the current position and the walking direction of the pedestrian by referring to the walking guidance information database; and
a guidance sound source reproducing unit configured to reproduce a guidance sound source corresponding to the guidance information in three dimensions based on the current position and the walking direction of the pedestrian.

2. The walking guidance apparatus of claim 1, wherein, when a relationship between each corresponding point found in an adjacent image and the camera does not correspond to a relationship between images defined by epipolar geometry, the corresponding point search unit removes the corresponding point.

3. The walking guidance apparatus of claim 1, wherein the current position and walking direction calculation unit calculates the 3D position and pose of the camera between the images using the camera internal parameters and the relationship between corresponding points; and compensates far scales of the 3D position and pose of the camera using an actual size of an object included in the acquired image.

4. The walking guidance apparatus of claim 1, wherein the current position and walking direction calculation unit calculates the current position and walking direction of the pedestrian by accumulating variations between a 3D position and pose of the camera calculated in an image captured at an initial position and a 3D position and pose of the camera calculated in an image captured after capturing the image at the initial position.

5. The walking guidance apparatus of claim 1, wherein the guidance information generating unit generates the guidance information including route deviation information and walking speed comparison information by comparing route trajectory information for a walking zone, a walking speed in the walking zone, and a time duration in the walking zone that are stored in the walking guidance information database with the current position and walking direction of the pedestrian.

6. The walking guidance apparatus of claim 1, wherein the guidance information generating unit searches for a landmark within a walking guidance range that is preset based on the current position of the pedestrian from the walking guidance information database, and calculates a relative distance and a direction of a found landmark based on the current position and walking direction of the pedestrian.

7. The walking guidance apparatus of claim 6, wherein the guidance sound source reproducing unit adjusts a reproduction position and a reproduction direction of a guidance sound source corresponding to the guidance information based on the relative distance and the direction of the landmark.

8. A walking guidance method using a walking guidance information database, the walking guidance method comprising:
extracting a feature point from an acquired image;
searching for a corresponding point based on a correspondence relationship between feature points extracted from consecutive images;
calculating a current position and a walking direction of a pedestrian by calculating a three-dimensional (3D) position and pose of a camera between the images by using camera internal parameters and a relationship between corresponding points;
generating guidance information according to the current position and the walking direction of the pedestrian by referring to the walking guidance information database; and
reproducing a guidance sound source corresponding to the guidance information in three dimensions based on the current position and the walking direction of the pedestrian.

9. The walking guidance method of claim 8, wherein the searching for a corresponding point includes removing the corresponding point when a relationship between each corresponding point found in an adjacent image and the camera does not correspond to a relationship between images defined by epipolar geometry.

10. The walking guidance method of claim 8, wherein the calculating of the current position and the walking direction of the pedestrian includes:
calculating the 3D position and pose of the camera between the images using the camera internal parameters and the relationship between corresponding points; and
compensating for scales of the 3D position and pose of the camera using an actual size of an object included in the acquired image.

11. The walking guidance method of claim 8, wherein the calculating of the current position and walking direction of the pedestrian comprises calculating the current position and walking direction of the pedestrian by accumulating variations between a 3D position and pose of the camera calculated in an image captured at an initial position and a 3D position and pose of the camera calculated in an image captured after capturing the image at the initial position.

12. The walking guidance method of claim 8, wherein the generating of the guidance information includes generating the guidance information including route deviation information and walking speed comparison information by comparing route trajectory information for a walking zone, a walking speed in the walking zone, and a time duration in the walking zone that are stored in the walking guidance information database with the current position and walking direction of the pedestrian.

13. The walking guidance method of claim 8, wherein the generating of the guidance information includes:
searching for a landmark within a walking guidance range that is preset based on the current position of the pedestrian from the walking guidance information database; and
calculating a relative distance and a direction of a found landmark based on the current position and walking direction of the pedestrian.

14. The walking guidance method of claim 13, wherein the reproducing of the guidance sound source includes adjusting a reproduction position and a reproduction direction of a guidance sound source corresponding to the guidance information based on the relative distance and the direction of the landmark.

15. A method of constructing a walking guidance information database, the method comprising:
constructing pedestrian route data including information about positions and postures of a pedestrian which moved by accumulating variations between a three-dimensional (3D) position and pose of a camera calculated in an image captured at an initial position and a 3D position and pose of the camera calculated in an image captured after capturing the image at the initial position, and
constructing landmark data including a position of a landmark set by a user based on the initial position, guidance information for the landmark, and a walking guidance range.
